(19) United States
(12) Patent Application Publication
(10) Pub. No.: US 2003/0096721 A1
(43) Pub. Date: May 22, 2003

(54) Complex for catalytically bleaching a substrate

(75) Inventor: Ronald Hage, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/165,882

(22) Filed: Jun. 10, 2002

(30) Foreign Application Priority Data
Jun. 11, 2001 (GB) 0114155.5

(51) Int. Cl. C11D 3/00; D06M 10/00

(52) U.S. Cl. 510/311; 510/312; 510/314; 510/376; 8/115.51

(57) ABSTRACT

The invention relates to catalytically bleaching substrates, especially laundry fabrics, with atmospheric oxygen or air. A method of bleaching a substrate is provided that comprises applying to the substrate, in an aqueous medium, a water soluble transition metal complex for bleaching of the substrate by atmospheric oxygen.

### FIELD OF INVENTION

This invention relates to a class of complex useful as catalysts for catalytically bleaching substrates with atmospheric oxygen.

### BACKGROUND OF INVENTION

The use of bleaching catalysts for stain removal has been developed over recent years. The recent discovery that some catalysts are capable of bleaching effectively in the absence of an added peroxyl source has recently become the focus of some interest, for example: WO9965905; WO0012667; WO0012808; and, WO0029537.

EP 0306089 (Unilever) discloses a process for cleaning and bleaching fabrics comprising the treatment of the fabric with a metallo-porphyrin compound, leaving the fabric in contact therewith for a predetermined time to effect sufficient adsorption of metallo-porphyrin on to the fabric, and thereafter washing the fabric with a peroxyacid bleach composition. Compositions for use in this cleaning and bleaching process and pretreatment products for local application of metallo-porphyrin catalyst on to fabrics are also disclosed.

J. E. Lyons et al., in J. of Catalysis: 59-73, 1995 discloses the use metallo-porphyrins in the oxidation of alkanes with oxygen and B. Meunier in Chem. Rev., 92, 1411 (1992) provides a review on metalloporphyrin oxidation chemistry.

The search for new classes of compounds that are suitable as air bleaching catalyst is ongoing.

### SUMMARY OF INVENTION

Surprisingly, we have found that a class of metalloporphyrins are capable of bleaching a chromophore with air.

The present invention provides a method of bleaching a textile in an aqueous environment, said method comprising treating the textile with a bleaching composition comprising a transition metal complex of a ligand of general formula (L), the transition metal complex having a water solubility of at least 0.1 g/l, the ligand having the following structure:

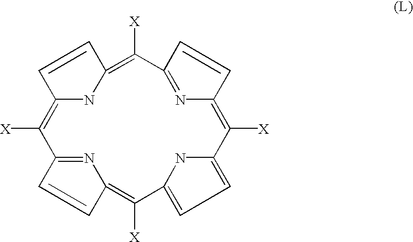

wherein at least one X is selected from a moiety that forms a charged species in an aqueous solution, together with at least 1% of a surface active material, followed by a subsequent step of drying the textile and wherein said method omits a step of adding a peracid or hydrogen peroxide source to the aqueous environment that are not formed by adventitious autoxidation of the bleaching composition. In the method it is preferred that the textile in the aqueous medium is agitated.

In the method at least 10%, preferably at least 50% and optimally at least 90% of any bleaching of a substrate is effected by oxygen sourced from the air.

One skilled in the art of laundry will appreciate that the term “dry” and “drying” when applied to a laundry fabric is different to that found in other arts. These terms as used herein are used to indicate water content of a laundry fabric and the processing of a laundry fabric to a state. The term “dry”, as used herein, is one where a member of the public would consider a laundry fabric to be dry and suitable for wearing. Generally, such a state is found when the moisture content of the laundry fabric is such that it is in equilibrium with the atmospheric conditions of its surroundings. Obviously, the moisture content of a “dry” cotton textile will be greater as a result of water that is hydrogen bound to the cotton than that of say a polyester textile. A more specific definition of “dry” fabric is provided in contrast to “bone dry” fabric which is the completely dehydrated fabric. A “bone dry” fabric has a dehydrated weight and “regain weight” which is the percentage weight of moisture taken up, regained, when the “bone dry” fabric is allowed to equilibrate for at least 24 hours in an environment of 65% humidity at 20° C., for example as approximately provided for by tumble drying a fabric followed by airing the fabric on a clothes line. A “dry” fabric may be considered one that is at this regain level but not significantly above it. The following are approximate percentage weight “regains” of differing fabrics: polyester 0.7-1%; nylon 3.5%; wool 13%; viscose rayon 12%; and cotton 7%.

In typical washing compositions the level of the transition metal complex of a ligand (L) is such that the in-use level is from 0.1 μM to 50 mM, with preferred in-use levels for domestic laundry operations falling in the range 1 to 100 μM. Higher levels may be desired and applied in industrial bleaching processes, such as textile and paper pulp bleaching.

Preferably, the aqueous medium has a pH in the range from pH 6 to 13, more preferably from pH 6 to 11, still more preferably from pH 8 to 11, and most preferably from pH 8 to 10, in particular from pH 9 to 10.

The present invention further provides a dry textile having a transition metal complex of a ligand (L) as defined above applied or deposited thereon, whereby bleaching by atmospheric oxygen is catalysed on the textile.

The present invention extends to a commercial package comprising the bleaching composition according to the present invention together with instructions for its use. The bleaching composition is substantially devoid of any added peroxyl species. As one skilled in the art will appreciate some organic molecules are susceptible to autoxidation. In this regard, it is difficult to provide a composition that is completely free of hydroperoxide. Nevertheless, the use of amounts of antioxidant will serve to reduce the level of adventitious hydroperoxide present in any composition. It is permissible for the bleaching composition to have up to 1% of a hydroperoxyl containing moiety present, preferably below 0.1%. The instructions for use may indicate that no added peroxide should be added during a laundry wash with a composition of the present invention.

Advantageously, by enabling a bleaching effect even after the textile has been treated, the benefits of bleaching can be prolonged on the textile. Furthermore, since a bleaching effect is conferred to the textile after the treatment, the treatment itself, such as a laundry wash cycle, may for example be shortened. Moreover, since a bleaching effect is achieved by atmospheric oxygen after treatment of the textile, hydrogen peroxide or peroxy-based bleach systems can be omitted from the treatment substance.

In a preferred embodiment, the treated textile is dried, by allowing it to dry under ambient temperature or at elevated temperatures. The elevated temperatures are commonly provided by a heated agitated environment, as for example found in a tumble dryer, which has been found to accelerate and enhance the air bleaching effect.

### SUMMARY OF THE INVENTION

The X Group

It is essential that the porphyrin of the present invention has at least one X moiety that has a water solubilising group, preferably all four Xs are the same. Preferred water soluble groups are provided by a quaternized nitrogen. A quaternized nitrogen may be formed from: heterocyclic nitrogen, aliphatic amines. These compounds are readily formed by adding an hydrocarbon that has an labile leaving group, for example an alkyl halide, diazomethane, or dialkyl sulphate to an amine. It will be evident to one skilled in the art that quaternized nitrogen compounds are easily prepared.

Suitable groups for X are, for example: quaternized nitrogen, phenolic-OH, zwitterionic groups, sulphate, sulphonate, phosphate, boronates, phosphonate, guanidinium, carboxylate derivative, and an amine having pKa>9 which is in the form of an acid salt, examples of such amines are piperidine, octylamine, 1,4,7-triazacyclononane type moieties, etc. The amine having pKa>9 would therefor would not be based out in wash solutions having a pH of 9 and would remain as the water soluble salt.

It is preferred that the X groups are phenyl or pyridyl groups that are substituted or derivatized to have a charged water solubilizing moiety bound thereto.

Examples of suitable X groups that may be used are found below.

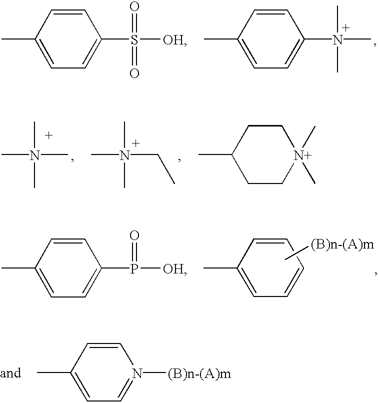

wherein n and m may be 0 or 1, A may be sulphate, sulphonate, phosphate or carboxylate groups; and B is selected from C1-C10-alkyl, polyethoxyalkyl or hydroxyalkyl and other suitable groups for example boronates, e.g., —C6H4-B(OH)2.

The Counter Ion

Examples of suitable counter ions which balance the charge on the complex are ClO₄⁻, BR₄⁻, [FeCl₄]⁻, PF₆⁻, RCOO⁻, NO₃⁻, NO₂⁻, RO⁻, N⁺RR′R″R″′, Cl⁻, Br⁻, F⁻, I⁻, RSO₃⁻, S₂O₆²⁻, OCN⁻, SCN⁻, Li⁺, Ba²⁺, Na⁺, Mg²⁺, K⁺, Ca²⁺, Cs⁺, PR₄⁺, RBO₂²⁻, SO₄²⁻, HSO₄⁻, SO₃²⁻, SbCl₆⁻, CuCl₄²⁻, CN, PO₄³⁻, HPO₄²⁻, H₂PO₄⁻, STP-derived anions, CO₃²⁻, HCO₃⁻ and BF₄⁻, and more preferably selected from ClO₀⁻, BR₄⁻, [FeCl₄]⁻, PF₆⁻, RCOO⁻, NO₃⁻, NO₂⁻, RO⁻, N⁺RR′R″R′″, Cl⁻, Br⁻, F⁻, I⁻, RSO₃⁻ (preferably CF₃SO₃⁻), S₂O₆²⁻, OCN⁻, SCN⁻, Li⁺, Ba₂₊, Na⁺, Mg²⁺, K⁺, Ca²⁺, PR₄⁺, SO₄²⁻, HSO₄⁻, SO₃₂₋, and BF₄⁻.

The Bleaching Composition

The bleaching composition of the present invention has particular application in detergent formulations, especially for laundry cleaning. Accordingly, in another preferred embodiment, the present invention provides a detergent bleach composition comprising a bleaching composition as defined above and additionally a surface-active material, optionally together with detergency builder.

The bleach composition according to the present invention may for example contain additional surface-active material in an amount of from 10 to 50% by weight. The surface-active material may be naturally derived, such as soap, or a synthetic material selected from anionic, nonionic, amphoteric, zwitterionic, cationic actives and mixtures thereof. Many suitable actives are commercially available and are fully described in the literature, for example in “Surface Active Agents and Detergents”, Volumes I and II, by Schwartz, Perry and Berch.

Typical synthetic anionic surface-actives are usually water-soluble alkali metal salts of organic sulphates and sulphonates having alkyl groups containing from about 8 to about 22 carbon atoms, the term “alkyl” being used to include the alkyl portion of higher aryl groups. Examples of suitable synthetic anionic detergent compounds are sodium and ammonium alkyl sulphates, especially those obtained by sulphating higher (C₈-C₁₈) alcohols produced, for example, from tallow or coconut oil; sodium and ammonium alkyl (C₉-C₂₀) benzene sulphonates, particularly sodium linear secondary alkyl (C₁₀-C₁₅) benzene sulphonates; sodium alkyl glyceryl ether sulphates, especially those ethers of the higher alcohols derived from tallow or coconut oil fatty acid monoglyceride sulphates and sulphonates; sodium and ammonium salts of sulphuric acid esters of higher (C₉-C₁₈) fatty alcohol alkylene oxide, particularly ethylene oxide, reaction products; the reaction products of fatty acids such as coconut fatty acids esterified with isethionic acid and neutralised with sodium hydroxide; sodium and ammonium salts of fatty acid amides of methyl taurine; alkane monosulphonates such as those derived by reacting alpha-olefins (C₈-C₂₀) with sodium bisulphite and those derived by reacting paraffins with SO₂ and Cl₂ and then hydrolysing with a base to produce a random sulphonate; sodium and ammonium (C₇-C₁₂) dialkyl sulphosuccinates; and olefin sulphonates, which term is used to describe material made by reacting olefins, particularly (C₁₀-C₂₀) alpha-olefins, with SO₃ and then neutralising and hydrolysing the reaction product. The preferred anionic detergent compounds are sodium (C₁₀-C₁₅) alkylbenzene sulphonates, and sodium (C₁₆-C₁₈) alkyl ether sulphates.

Examples of suitable nonionic surface-active compounds which may be used, preferably together with the anionic surface-active compounds, include, in particular, the reaction products of alkylene oxides, usually ethylene oxide, with alkyl (C₆-C₂₂) phenols, generally 5-25 EO, i.e. 5-25 units of ethylene oxides per molecule; and the condensation products of aliphatic (C₈-C₁₈) primary or secondary linear or branched alcohols with ethylene oxide, generally 2-30 EO. Other so-called nonionic surface-actives include alkyl polyglycosides, sugar esters, long-chain tertiary amine oxides, long-chain tertiary phosphine oxides and dialkyl sulphoxides.

Amphoteric or zwitterionic surface-active compounds can also be used in the compositions of the invention but this is not normally desired owing to their relatively high cost. If any amphoteric or zwitterionic detergent compounds are used, it is generally in small amounts in compositions based on the much more commonly used synthetic anionic and nonionic actives.

The detergent bleach composition of the invention will preferably comprise from 1 to 15% wt of anionic surfactant and from 10 to 40% by weight of nonionic surfactant.

The bleach composition of the present invention may also contain a detergency builder, for example in an amount of from about 5 to 80% by weight, preferably from about 10 to 60% by weight.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate; nitrilotriacetic acid and its water-soluble salts; the alkali metal salts of carboxymethyloxy succinic acid, ethylene diamine tetraacetic acid, oxydisuccinic acid, mellitic acid, benzene polycarboxylic acids, citric acid; and polyacetal carboxylates as disclosed in U.S. Pat. No. 4,144,226 and U.S. Pat. No. 4,146,495.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

In particular, the compositions of the invention may contain any one of the organic and inorganic builder materials, though, for environmental reasons, phosphate builders are preferably omitted or only used in very small amounts. Typical builders usable in the present invention are, for example, sodium carbonate, calcite/carbonate, the sodium salt of nitrilotriacetic acid, sodium citrate, carboxymethyloxy malonate, carboxymethyloxy succinate and water-insoluble crystalline or amorphous aluminosilicate builder materials, each of which can be used as the main builder, either alone or in admixture with minor amounts of other builders or polymers as co-builder.

Apart from the components already mentioned, the bleach composition of the present invention can contain any of the conventional additives in amounts of which such materials are normally employed in fabric washing detergent compositions. Examples of these additives include buffers such as carbonates, lather boosters, such as alkanolamides, particularly the monoethanol amides derived from palmkernel fatty acids and coconut fatty acids; lather depressants, such as alkyl phosphates and silicones; anti-redeposition agents, such as sodium carboxymethyl cellulose and alkyl or substituted alkyl cellulose ethers; stabilisers, such as phosphonic acid derivatives (i.e. Dequest® types); fabric softening agents; inorganic salts and alkaline buffering agents, such as sodium sulphate and sodium silicate; and, usually in very small amounts, fluorescent agents; perfumes; enzymes, such as proteases, cellulases, lipases, amylases and oxidases; germicides and colourants.

Transition metal sequestrants such as EDTA, and phosphonic acid derivatives such as EDTMP (ethylene diamine tetra(methylene phosphonate)) may also be included, in addition to the transition metal complex of a ligand (L) specified, for example to improve the stability sensitive ingredients such as enzymes, fluorescent agents and perfumes, but provided the composition remains bleaching effective.

The composition containing the bleach catalyst may contain additional enzymes as found in WO 01/00768 A1 page 15, line 25 to page 19, line 29, the contents of which are herein incorporated by reference.

The bleaching compositions according to the present invention may be used for laundry cleaning, hard surface cleaning (including cleaning of lavatories, kitchen work surfaces, floors, mechanical ware washing, etc.), as well as other uses where a bleach is needed, for example waste water treatment or pulp bleaching during manufacture of paper, dye transfer inhibition, starch bleaching, sterilisation and/or whitening in oral hygiene preparation, or contact lens disinfection.

Experimental

In an aqueous solution containing 10 mM carbonate buffer (pH 10) with 0.6 g/l NaLAS (linear alkylbenzene sulphonate), tomato-soya oil or curry extract stained cloths were added and kept in contact with the solution under agitation for 30 minutes at 30° C. In a comparative experiment, the same was done by addition of 10 μM of the compounds 1 to 5 to the wash liquor. The bleach results were compared with the results obtained for [Fe(MeN4py)Cl]Cl, the synthesis of which is described in WO 0116271.

We acknowledge Prof. J. Lindsay Smith (University of York, UK) for kindly providing the following compounds 1-4. Compound 5 (5,10,15,20-(tetrakis(pentafluorophenyl)-21H-23H-porphyin iron(III) chloride), (Chemical Abstracts Service Registry No [36965-72-6]) was obtained from Aldrich@. N. Colclough, J. R. Lindsay Smith, J. Chem. Soc., Perkin Trans, 2, 1139 (1994) on the same compounds as described herein the patent.

| Comp. | |
|---|---|
| 1 | 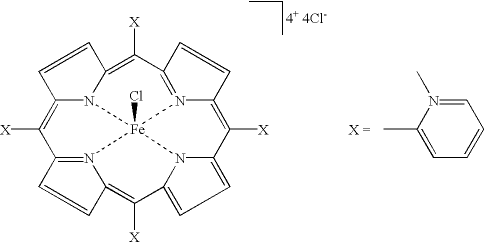 |
| | (Iron(III)tetra(2N-methylpyridyl)porphyrin |
| | chloride) |
| 2 | 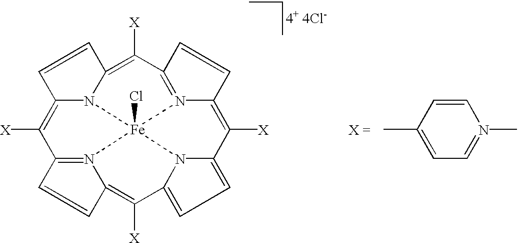 |
| | (Iron(III)tetra(4N-methylpyridyl) porphyrin |
| | chloride) |
| 3 | Compound 3, Manganese(III)tetra(2N- |
| | methylpyridyl)porphyrin chloride), which is the |
| | same as compound 1, except Mn instead of Fe. |
| 4 | Compound 4, Manganese(III)tetra(4N- |
| | methylpyridyl)porphyrin chloride), which is the |
| | same as compound 2, except Mn instead of Fe. |
| 5 | 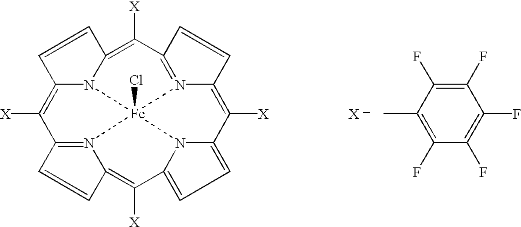 |
| | 5,10,15,20 (tetrakis(pentafluorophenyl)-21H-23H- |
| | porphyin iron(III) chloride) |

After the wash, the cloths were rinsed with water and subsequently dried at 30° C. and the change in colour was measured immediately after drying with a Linotype-Hell scanner (ex Linotype) (“t=0” in table 1) and after 1 day storage in the dark (“t=1” in table 1). For the curry stain only the bleaching performance immediately after drying was measured. The change in colour (including bleaching) is expressed as the ΔE value vs white, so a lower value means a cleaner cloth. The measured colour difference (ΔE) between the washed cloth and the unwashed cloth is defined as follows:

ΔE=[(ΔL)²+(Δa)²+(Δb)²]^{1/2}

wherein ΔL is a measure for the difference in darkness between the washed and unwashed test cloth; Δa and Δb are measures for the difference in redness and yellowness respectively between both cloths. With regard to this colour measurement technique, reference is made to Commission International de l'Eclairage (CIE); Recommendation on Uniform Colour Spaces, colour difference equations, psychometric colour terms, supplement no 2 to CIE Publication, no 15, Colormetry, Bureau Central de la CIE, Paris 1978.

The results are shown below in the tables (table 1: results for tomato oil stain and table 2: results for curry extract stain)

TABLE 1
Tomato oil stain bleaching

| | t = 0 | t = 1 |
|---|---|---|
| Blank | 16 | 17 |
| Compound 1 | 11 | 8 |
| Compound 2 | 17 | 12 |
| Compound 3 | 16 | 12 |
| Compound 4 | 16 | 13 |
| Compound 5 | 16 | 16 |
| FeMeN4pyCl₂ | 9 | 6 |

TABLE 2
Curry extract stain bleaching

| | t = 0 |
|---|---|
| Blank | 33 |
| Compound 1 | 20 |
| Compound 3 | 20 |
| Compound 4 | 21 |
| Compound 5 | 30 |
| FeMeN4pyCl₂ | 22 |

The results presented in the table show that the porphyrin compound 1 gives a good stain removal activity on both tomato and curry stains with atmospheric oxygen. Worse bleaching performance on tomato oil was observed with compounds 2, 3, and 4.

Comparative examples with FeMeN4pyCl2 shows that compound 1 has a similar performance. Compound 5 (uncharged porphyrin), shows a very poor result.

On curry extract stain, compound 1, 3, and 4 show excellent bleaching performance (comparable to FeMeN4pyCl2), with again the non-charged porphyrin showing a poor performance.

All the compounds 1-4 were also tested on tomato stain bleaching performance in the same buffer with LAS with 10 mM hydrogen peroxide present. None of the compounds showed any bleaching activity with respect to the blank. This shows that these compounds are preferably used in formulations without hydrogen peroxide present.

We claim:

1. A method of bleaching a textile in an aqueous environment, said method comprising treating the textile with a bleaching composition comprising a transition metal complex of a ligand of general formula (L), the transition metal complex having a water solubility of at least 0.1 g/l, the ligand having the following structure: 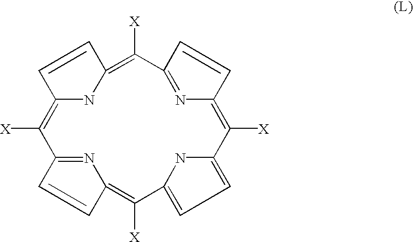
wherein at least one X is selected from a moiety that forms a charged species in an aqueous solution, together with at least 1% of a surface active material, followed by a subsequent step of drying the textile and wherein said method omits a step of adding a peracid or hydrogen peroxide source to the aqueous environment that are not formed by adventitious autoxidation of the bleaching composition.

2. A method according to claim 1, wherein the transition metal complex has a water solubility of at least 1.0 g/l.

3. A method according to claim 1, wherein all X are identical.

4. A method according to claim 3, wherein said least one X contains a group selected from a: quaternized nitrogen, phenolic-OH, zwitterionic groups, sulphate, sulphonate, phosphate, boronates, phosphonate, guanidinium, carboxylate derivative, and an amine having pKa>9.

5. A method according to claim 4, wherein X comprises a cationic species.

6. A method according to claim 5, wherein X comprises a quaternized nitrogen.

7. A method according to claim 6, wherein X is a pyridine moiety, wherein the nitrogen of the pyridine is quaternised.

8. A method according to claim 6, wherein X is selected from 2N-C1-C6-alkylpyridyl, 3N-C1-C6-alkylpyridyl, and 4N-C1-C6-alkylpyridyl.

9. A method according to claim 8, wherein X is selected from: 2N-methylpyridyl, 3N-meth ylpyridyl, and 4N-methylpyridyl.

10. A method according to claim 8, wherein X is 2N-methylpyridyl.

11. A method according to claim 1, comprising a surface-active material in an amount of from 10 to 50%.

12. A method according to claim 1, wherein the ligand forms a complex of the general formula (A1):
[MₐLₖXₙ]Yₘ (A1)
in which:
M represents a metal selected from Mn(II)-(III)-(IV)-(V), Cu(I)-(II)-(III), Fe(I)-(II)-(III)-(IV), Co(I)-(II)-(III), Ni(I)-(II)-(III), Cr(II)-(III)-(IV)-(V)-(VI)-(VII), Ti(II)-(III)-(IV), V(II)-(III)-(IV)-(V), Mo(II)-(III)-(IV)-(V)-(VI), W(IV)-(V)-(VI), Pd(II), Ru(II)-(III)-(IV)-(V) and Ag(I)-(II);
L represents a ligand, or its protonated or deprotonated analogue;
X represents a coordinating species selected from any mono, bi or tri charged anions and any neutral molecules able to coordinate the metal in a mono, bi or tridentate manner;
Y represents any non-coordinated counter ion;
a=k and represents an integer from 1 to 10;
n represents zero or an integer from 1 to 10; and
m represents zero or an integer from 1 to 20.

13. A method according to claim 12, wherein a=1 or 2.

14. A method according to claim 13, wherein a=1.

15. A method according to claim 12, wherein the M represents a metal selected from Mn(II)-(III)-(IV)-(V), and Fe(I)-(II)-(III)-(IV).
